(19) United States
(12) Patent Application Publication
(10) Pub. No.: US 2025/0331463 A1
(43) Pub. Date: Oct. 30, 2025

(54) PICK-UP ATTACHMENT FOR A HARVESTING MACHINE

(71) Applicant: Carl Geringhoff GmbH & Co. Kommanditgesellschaft, Ahlen (DE)

(72) Inventors: André HEMMESMANN, Sassenberg (DE); Andreas LEUDERALBERT-BOWE, Gronau (DE); Cristiano SCHWARTZ, Ahlen (DE); Holger STRUNK, Wadersloh (DE); Reimer Uwe TIESSEN, Oldenburg (DE)

(73) Assignee: Carl Geringhoff GmbH & Co. Kommanditgesellschaft, Ahlen (DE)

(21) Appl. No.: 18/867,116

(22) PCT Filed: Jun. 20, 2023
(86) PCT No.: PCT/DE2023/100463

§ 371 Date: Nov. 19, 2024

(30) Foreign Application Priority Data
Jun. 24, 2022 (DE) 10 2022 115 794.6

(51) Int. Cl. A01D 89/00; A01B 73/04

(52) U.S. Cl. CPC A01D 89/002; A01B 73/044

(57) ABSTRACT

A pick-up attachment for a harvesting machine preferably for a field chopper, particularly preferably for a self-propelled field chopper, includes a pick-up rotor having pick-up tools for picking crop up from the ground, at least one guide element that rests on the ground, which element takes on the guidance of the pick-up rotor and guides it relative to the ground, and a machine frame that is connected to the pick-up rotor. The pick-up rotor is composed of multiple segments connected to one another at least partially in an articulated manner, for adaptation to the contours of the ground. At least one guidance system movably connects the pick-up rotor, in particular a segment of the pick-up rotor, to the machine frame of the pick-up attachment.

The invention relates to a pick-up attachment for a harvesting machine, preferably for a field chopper, in particular for a self-propelled field chopper, comprising a pick-up rotor having pick-up tools for picking crop up from the ground, wherein the pick-up rotor is connected to at least one guide element that rests on the ground, which element takes on the guidance of the pick-up rotor and guides it relative to the ground.

Field choppers are harvesting machines that are used for harvesting and collecting crop, cutting crop to short parallel lengths, and conveying the chopped material into containers or separate vehicles. Typical crops are grasses, grass-like crops such as alfalfa or field grass, pulses, mixtures and/or crops grown in rows, such as maize or millet. The chopped material can either be fed to the livestock directly or stored by means of silage or drying, so that it can be fed to the livestock later, as fodder. The field chopper can harvest the crop directly, by means of cutting it off over its full width or from individual or multiple rows, or by picking it up from the swath.

Field choppers can be attached to a tractor, pulled by a tractor, or self-propelled.

A harvesting attachment is a device, usually removable, for picking the crop up into the field chopper. In the case of a pick-up attachment as a harvesting attachment, this is specifically a device for picking up crop that has been cut previously. In this regard, the crop can be laid down in rows or swaths.

When harvesting these crops, it is tremendously important to maintain a high quality of the crop and thereby a high quality of the fodder. The cleanliness of the crop has a decisive influence on the silage process and, when using the crop or the silage as fodder, on the health of the livestock, the life expectancy of the livestock, and thereby also in the milk performance and the meat yield.

Furthermore, the wear of the harvesting machines that process the crop, for example the chopping blades of the field choppers, is significantly reduced if the crop can be picked up with as little contamination as possible.

An optimal adjustment of the raking height, i.e. of the distance of the pick-up tools, in particular the pick-up tines or raking tines from the ground, in particular the soil, i.e. from the turf is crucial for gentle and clean pick-up of the crop.

The raking height is understood to be the distance between the raking point and the soil or the turf, wherein the raking point lies at the location where the envelope curve of the pick-up tools, in particular of the pick-up tines or raking tines of the pick-up rotor has the smallest distance from the ground or the turf.

The raking height or the distance of the pick-up tools from the ground should always be set in such a manner that the crop can be picked up from the ground completely, in other words without losses, and passed on to the harvesting machine, in particular to the field chopper. In this regard, it is important that the pick-up tools, in particular the pick-up tines of the pick-up rotor do not engage into the soil or into the turf and thereby carry contamination into the crop and thereby into the fodder.

If the raking height is set too high, i.e. if the distance of the pick-up tools from the ground is too great, the pick-up tools, in particular the pick-up tines no longer pick all of the crop up from the ground. Crop remains lying in the ground and thereby on the field, and thereby the crop yield is reduced and the further growth of the crop, for example of the grass, is inhibited.

If the raking height is set too low, i.e. if the distance of the pick-up tools from the ground is too small, the pick-up tools, in particular the pick-up tines engage into the ground or the turf. This results in increased contamination of the crop and fodder, damage to the ground, in particular the turf, as well as increased wear of the pick-up attachment and of the harvesting machine, in particular of the field chopper, going as far as breakage of the pick-up tools, in particular of the pick-up tines, of the pick-up rotor or further damage to the pick-up attachment and/or the harvesting machine.

Setting and maintaining the raking height, i.e. the distance of the pick-up tools from the ground or the turf, is therefore a very important factor for increasing the quality of the crop or fodder, as well as for reducing damage to the field, to the ground or the turf, to the pick-up attachment and/or the harvesting machine. Setting and maintaining the raking height, i.e. the distance of the pick-up tools from the ground or the turf is very important, in particular in the case of pick-up attachments that have a large working width oriented transverse to the direction of travel.

Aside from the possibility of adjusting the height of the pick-up attachment that is provided on the field chopper and on the pick-up attachment, so as to uniformly adapt the raking height over the entire working width, it should also be possible to adapt the raking height within the working width, in other words transverse to the direction of travel, to changes in the ground contour or to an uneven turf.

Known pick-up attachments for field choppers comprise a rigid roller-like pick-up rotor having pick-up tools for picking crop up from the ground. The rigid roller-like pick-up rotor is guided with guide elements, namely feeler wheels or feeler skids, to and over the ground. Such guide elements are arranged, in each instance, on the outside next to the pick-up rotor, in other words outside of the effective working width. In this regard, the roller-like pick-up rotor describes a rigid cylindrical body that extends between the two guide elements. Such a construction of a pick-up attachment, i.e. such a rigid roller-like pick-up rotor has the disadvantage, on an uneven terrain, in other words a terrain that does not proceed evenly and has different high points, low points, irregularities or shapes over the width of the pick-up rotor, that the raking height cannot be adapted to the uneven ground contours within the working width of the pick-up attachment. On the one hand, it is a disadvantage that the crop or harvested material is not collected in low points of the terrain, since the pick-up tools, in particular the raking tines of the rigid pick-up rotor do not reach all the way to the ground or the turf, and this leads to crop losses. On the other hand, it is a disadvantage that in high points, the pick-up tools, in particular the raking tines of the rigid pick-up rotor aggressively comb through the ground or the turf, and this leads to massive contamination of the crop and thereby of the fodder, and therefore to a reduction in quality of the crop and thereby the fodder, damage to the turf, and increased machine wear of both the pick-up attachment and the harvesting machine, in particular the field chopper, since a lot of dirt, in particular sand and soil is picked up along with the crop. The aforementioned disadvantageous effects are all the more increased the greater the working width of the pick-up attachment.

Greater advancing speeds also reinforce these disadvantages, since the possibility provided in the harvesting machine, in particular the field chopper, to guide the height of the pick-up attachment, works too slowly starting from a specific advancing speed, and therefore can no longer guide the pick-up attachment reliably relative to the ground.

Proceeding from this state of the art, the invention is based on the task of improving a pick-up attachment.

This task is accomplished with a pick-up attachment that has the characteristics of claim 1. Further developments and advantageous embodiments of the invention are evident from the dependent claims.

The pick-up attachment according to the invention, for a harvesting machine, preferably for a field chopper, particularly preferably for a self-propelled field chopper, comprises a pick-up rotor having pick-up tools for picking crop up from the ground, at least one guide element that rests on the ground and takes on the guidance of the pick-up rotor and guides it relative to the ground, and a machine frame that is connected to the pick-up rotor, wherein the pick-up rotor is composed of multiple segments connected to one another at least partially in an articulated manner, for adaptation to the contours of the ground, and wherein at least one guidance system is provided for a movable connection of the pick-up rotor, in particular of a segment of the pick-up rotor, to the machine frame of the pick-up attachment.

Because the pick-up rotor of the pick-up attachment is composed of multiple segments that are connected to one another in an articulated manner, at least in part, the result is achieved that the pick-up rotor is flexible, and thereby it can adapt to the ground contour. Therefore it is possible that the pick-up rotor adapts, at least in part, to the contour of a dip when traveling over the dip, or, vice versa, to the contour of an elevation when traveling over the elevation. In this regard, the pick-up rotor virtually hangs downward at the location in question or, vice versa, it arches upward at the location in question. Because the pick-up rotor of the pick-up attachment is configured to be flexible, it is possible to increase the working width of the pick-up attachment so as to increase the pick-up capacity. Pick-up attachments configured in this manner are particularly suitable in the case of greater working widths on uneven terrain. Because the pick-up rotor adapts to the contour of the terrain in this regard, the pick-up rotor and thereby the pick-up tools, in particular the raking tines, can be guided at an optimal distance from the turf so as to pick up the crop. Therefore no crop losses occur, since the crop material is reliably picked up even in dips of the terrain. Furthermore, the pick-up tools, in particular the raking tines, are prevented from aggressively combing through the turf. Since the turf is protected in this manner, and no dirt, such as sand or soil, is picked up, contamination of the crop and therefore of the fodder is prevented, and the quality of the crop and therefore of the fodder is increased. The flexibility of the pick-up rotor therefore guarantees high fodder quality along with low crop losses. Furthermore, increased machine wear is avoided, both on the pick-up attachment and on the harvesting machine, in particular the field chopper. It is even possible to increase the working speed of the harvesting machine, in particular the field chopper, and thereby of the pick-up attachment, on the basis of the flexible pick-up rotor, to increase the pick-up capacity. The pick-up rotor is preferably flexible over the entire working width. This can be ensured by means of numerous segments connected to one another in an articulated manner. The flexibility of the pick-up rotor over the entire working width allows optimal picking up of the crop, even if the pick-up attachment is simultaneously being guided over at least one dip and/or over at least one elevation of the uneven terrain. As a result, overall high fodder quality at low crop losses is guaranteed. Preferably, multiple guide elements are provided, distributed over the working width of the pick-up attachment, which elements take on the guidance of the pick-up rotor and/or guide it relative to the ground. Guide elements that are arranged to the side next to the pick-up rotor are preferably not provided. It can be advantageous if the guide elements, preferably slide plates, are arranged below and/or directly behind the pick-up rotor and/or within its effective working width. As a result, the pick-up rotor can adapt to the ground contours of the terrain over its entire working width.

Because at least one guidance system is provided for a movable or flexible connection of the pick-up rotor, in particular of a segment of the pick-up rotor, to the machine frame of the pick-up attachment, an additional relative motion, for example a kind of vertical up and down movement, is permitted between the pick-up rotor and the machine frame of the pick-up attachment, so that the ground adaptation of the pick-up attachment is clearly improved. This combination, according to the invention, of a flexible pick-up rotor and the at least one guidance system, for a movable or flexible connection of the pick-up rotor, in particular of a segment of the pick-up rotor to the machine frame of the pick-up attachment, is advantageous, above all, on very uneven terrain and at high advancing speeds, since the known systems on the harvesting machine, in particular on a field chopper, which systems are structured as contact pressure controllers, reach their limits at high advancing speeds when adjusting the height guidance of the pick-up attachment. In this case, the flexible pick-up rotor adapts directly and reactively to the uneven ground.

The guidance system according to the invention is configured in such a manner that it absorbs shear forces and pressure forces in or counter to the direction of travel of the pick-up attachment, which forces can be introduced into the guidance system by the guide elements, in particular slide plates, or by the pick-up rotor.

Furthermore, the guidance system according to the invention is configured in such a manner that it conducts away horizontal torques, which result from contact of the pick-up rotor or of the guide elements, in particular the slide plates, with the crop or the ground, as well as vertical torques that result from transverse forces from the guide elements, in particular the slide plates, during travel of the pick-up attachment along a curve, into the machine frame. At the same time, the guidance system guarantees a degree of freedom in which the pick-up rotor or the at least one segment of the pick-up rotor can swing up and down, so as to allow intentional movement or flexibility between the pick-up rotor and the machine frame.

The use of a guidance system for a movable or flexible connection of the pick-up rotor and the machine frame has the advantage that for this purpose, only a relative small construction space is needed within the pick-up attachment for harvesting machines, such as field choppers, loading wagons or presses. A guidance system therefore allows a compact construction of the pick-up attachment and ensures that other functions of the pick-up attachment, for example the folding mechanism for folding the machine frame of the pick-up attachment into a predetermined transport width or for folding the machine frame of the pick-up attachment out into a predetermined working width, is not impaired.

It can be advantageous if the guidance system has a first guide means, connected to the machine frame in a locally fixed manner, preferably a guide motion link or a guide rail, and a second guide means connected to the pick-up rotor, in particular to a segment of the pick-up rotor, in a locally fixed manner, preferably a guide carriage, guide wagon or the like, wherein the first and the second guide means are connected to one another and can be moved relative to one another along a guide track or running track, in particular up and down, in other words away from the ground and toward the ground.

It can be advantageous if the guidance system is a linear guidance system.

It can be advantageous if multiple guidance systems are provided, spaced apart from one another over the working width of the pick-up rotor.

It can be advantageous if the number of guidance systems corresponds to the number of guide elements provided preferably within the working width of the pick-up rotor. For some cases of use, the number of guidance systems can also be less than the number of guide elements provided preferably within the working width of the pick-up rotor.

It can be advantageous if each guidance system is centrally assigned to a guide element, in particular to a slide plate.

It can be advantageous if the guidance system is configured as a slide guide having at least one slide bearing element or as a roller guide having at least one roller bearing element.

It can be advantageous if the roller guide is a profile motion link guide or profile rail guide, in which rolling bodies, in particular balls or rollers, roll between the first guide means and the second guide means on a guide track or running track, or if the roller guide is a track roller guide in which track rollers mounted on rolling bodies roll between the first guide means and the second guide means on a guide track or running track.

It can be advantageous if one or more track rollers, preferably four track rollers are arranged on the guide carriage, with an upper and a lower track roller, in each instance, seen in or counter to the direction of travel of the pick-up attachment, being supported in a left and a right guide track or running track of the guide motion link.

By means of such a geometrical arrangement of the track rollers or of the slide bearing elements and/or roller bearing elements, a particularly stable introduction of load is guaranteed, along with very quiet running and process reliability in the guidance of the pick-up rotor.

It can be advantageous if the distance of the track rollers from one another, in the vertical and/or the horizontal direction, in the guidance system, is selected to be as great as technically possible.

By means of such a geometrical arrangement of the track rollers or of the slide bearing elements and/or roller bearing elements, a particularly stable introduction of load is guaranteed, along with very quiet running and process reliability in the guidance of the pick-up rotor.

It can be advantageous if the distance of the lower track rollers from the contact point of the guide element, in particular of a slide plate, is selected to be as low as technically possible in the vertical direction.

The contact point of the guide element, in particular of the slide plate, is the point at which the guide element, in particular the slide plate, comes into contact with the ground.

By means of such a geometrical arrangement of the track rollers or of the slide bearing elements and/or roller bearing elements, a particularly stable introduction of load is guaranteed, along with very quiet running and process reliability in the guidance of the pick-up rotor.

It can be advantageous if the guidance system, preferably the guide motion link and/or the guide carriage, has one or more stops for limiting the movement between the guide means, wherein preferably at least one upper and at least one lower stop limit the guide track or running track.

The stops make contact, accordingly, on the machine frame and/or on contact surfaces provided on at least one guide means. In this way the upper and lower end position of the flexible pick-up rotor or segment of the pick-up rotor connected to the guidance system is established.

It can be advantageous if the stops are configured to be interchangeable, differently configured and/or differently adjustable, preferably attachable at different positions of the guidance system, in particular so as to be screwed on.

In this way, the end positions of the flexible pick-up rotor or segment of the pick-up rotor connected to the guidance system can be individually established on every guidance system, in other words, in particular, the distance for a complete up and down movement can be individually established and limited differently on every guide system, over the working width of the pick-up rotor.

It can be advantageous if the stops are structured as stop dampers or stop buffers and/or as fixed stops or as a combination of damping and fixed stops.

It can be advantageous if the stops or end positions of the guidance systems arranged closer to the center of the pick-up attachment are selected and arranged in such a manner that the movement between the guide means is restricted more greatly than between the guide means of the guidance systems arranged farther out.

As a result, uniform and homogeneous bending of the flexible bending of the flexible pick-up rotor can be adjusted, and this in turn has a decisive influence on the durability of the rotor shaft.

It can be advantageous if each linear guidance system can be adjusted in such a manner that its guide track or running track is arranged to be perpendicular to the ground and/or in a direction that deviates from this or at an angle that deviates from this.

Depending on the arrangement, the performance of ground adaptation can be advantageously changed. If, for example, one or more than one guidance system is arranged in such a manner that the segments of the flexible pick-up rotor can escape upward and, at the same time, to the back, in other words counter to the direction of travel, then the self-locking effect as well as the ground pressure of the guide elements, in particular of the slide plates, is advantageously reduced.

It can be advantageous if a central guide means, in particular a central guide motion link, in particular a continuous pressure plate or contact surface, is connected to or integrated into the machine frame, in a locally fixed manner and preferably in one piece.

It is advantageous that guide means connected to the pick-up rotor or to predetermined segments of the pick-up rotor, in a locally fixed manner, can support themselves on the above guide means, and interact with it to produce a movable or flexible connection between the pick-up rotor and the machine frame, preferably in such a manner that the introduction of load and degrees of freedom described above are created.

After all this, the following advantages of the invention exist as compared with the state of the art:
better ground adaptation, above all in the case of greater working widths and forward drive speeds of the pick-up attachment
higher quality of the crop and thereby of the fodder, since less dirt is entrained into the crop and thereby into the fodder
less wear of the pick-up attachment and of the subsequent harvesting machine
reduction in the risk of breakage of the pick-up tools, in particular of the raking tines
reduced crop losses during pick-up of the crop material, due to an increase in raking quality
compact construction of the pick-up attachment for use on harvesting machines, such as field choppers, loading wagons or presses
low-wear configuration of the movable or flexible connection between the pick-up rotor and the machine frame of the pick-up attachment, by means of the use of roller bearings, slide bearings and/or roller-mounted track rollers
optimally adjustable bending and flexibility of the pick-up rotor due to the individual adjustability of the stops
efficient and cost-saving configuration of the movable or flexible connection between the pick-up rotor and the machine frame of the pick-up attachment, as a linear guidance system

Further characteristics of the invention are evident from the claims, the figures, and the figure description. All of the characteristics and combinations of characteristics mentioned above in the specification, as well as the characteristics and combinations of characteristics below, in the figure description, and/or only shown in the figures, can be used not only in the combination indicated, in each instance, but also in other combinations or by themselves.

The invention will now be explained in greater detail using preferred exemplary embodiments and making reference to the attached drawings. These show:

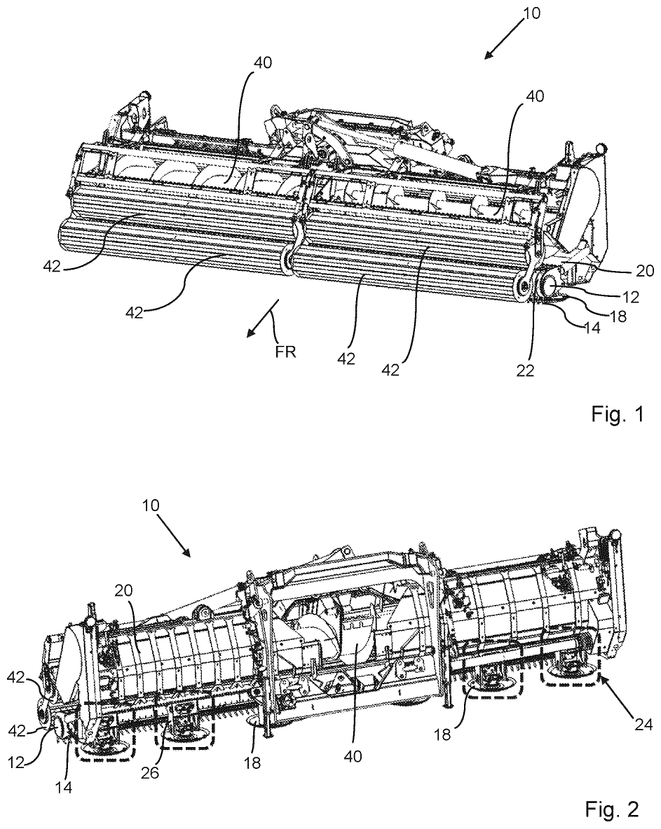

FIG. 1 a schematic perspective front view of a folding pick-up attachment according to the invention from,

FIG. 2 a schematic perspective rear view of the pick-up attachment according to the invention, according to FIG. 1,

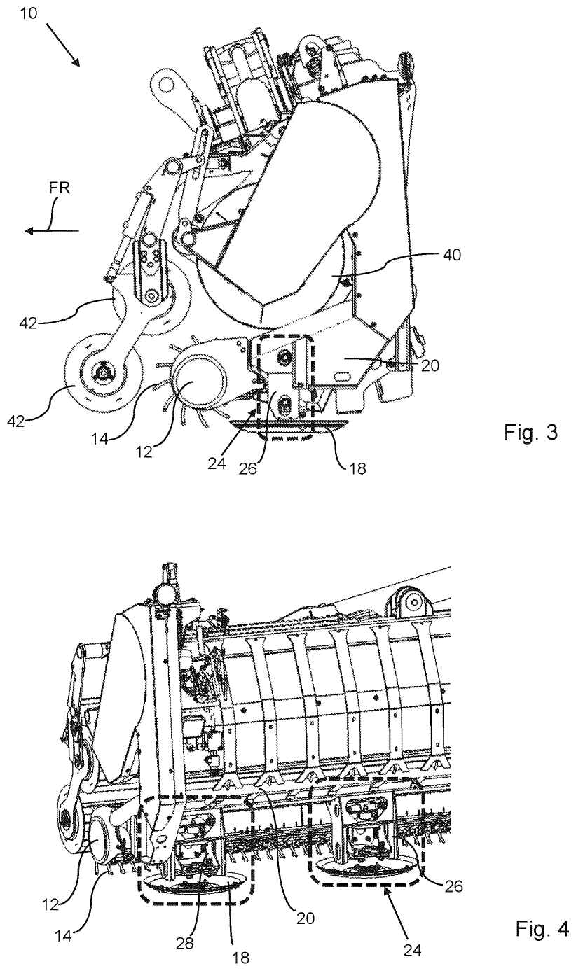

FIG. 3 a schematic side view of the pick-up attachment according to the invention, according to FIG. 1,

FIG. 4 a schematic perspective rear view of a detail of the pick-up attachment according to the invention, according to FIG. 2,

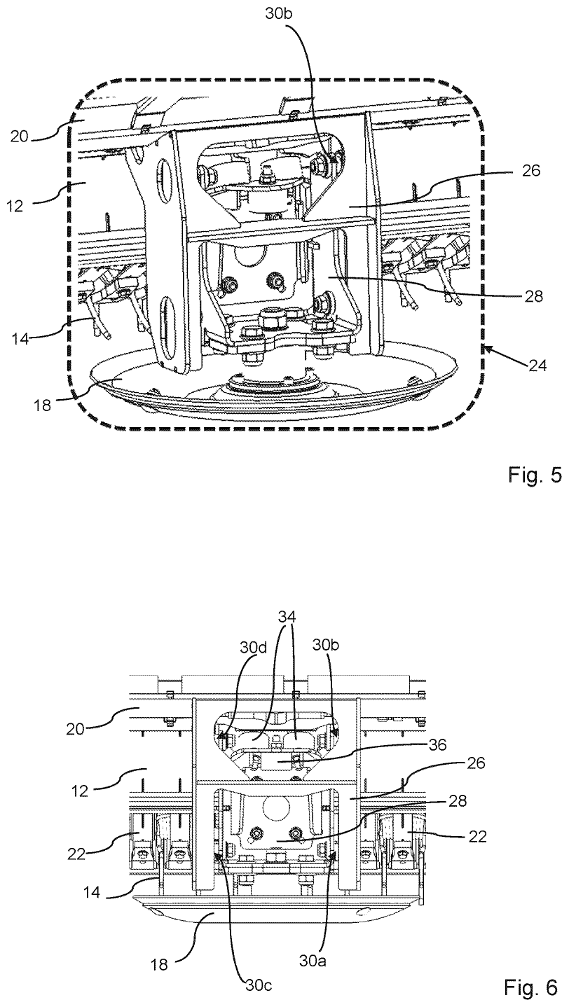

FIG. 5 a schematic perspective rear view of a detail of the pick-up attachment according to the invention, according to FIG. 4,

FIG. 6 a schematic rear view of the detail according to FIG. 5, and

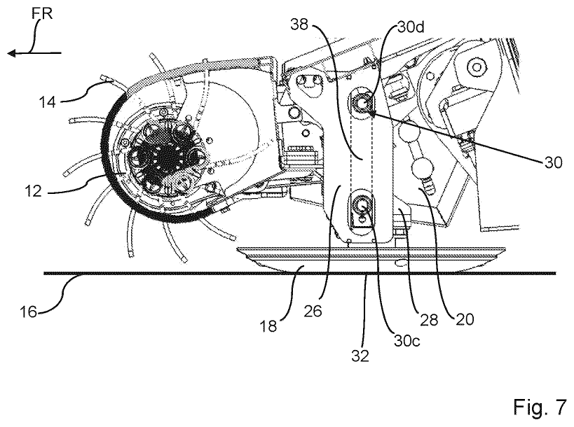

FIG. 7 a schematic side view of a detail of the pick-up attachment according to the invention, according to FIG. 3.

If the same reference numbers are used in FIGS. 1 to 7, they also refer to the same parts or regions.

FIGS. 1 and 2 each show a perspective view of a folding pick-up attachment 10, for one thing from the front, in other words counter to the direction of travel FR, and for another thing from the rear, in other words in the direction of travel FR. The direction of travel FR or the forward travel direction of the pick-up attachment 10 is indicated with an arrow in FIG. 1 and in FIG. 3. In FIG. 3, a side view of the folding pick-up attachment 10 according to FIG. 1 is shown schematically.

The folding pick-up attachment 10 for a self-propelled field chopper, not shown here, comprises a machine frame 20, which carries two machine halves that can be folded apart and folded together by way of a folding mechanism.

Each machine half comprises a pick-up rotor 12 having pick-up tools 14, which are configured as raking tines in the present case, for picking crop up from the ground 16, wherein each pick-up rotor 12 is connected to three guide elements 18 that are configured as slide plates in the present case and rest on the ground or the substratum. In this regard, the guide elements 18 are arranged, as shown in FIG. 2, directly behind the pick-up rotor 12 and within the effective working width of the pick-up rotor 12. The guide elements 18 take on the guidance of the pick-up rotor 12 and guide it relative to the ground 16. The ground 16 usually is usually formed by the turf. Furthermore, each machine half has a transverse conveying screw 40 that brings together the crop that has been picked up and transfers it to the field chopper as a crop mat. Furthermore, each machine half comprises what are called hold-down mechanisms 42, preferably in the form of rollers, which predetermine the direction of the crop flow when the crop is being conveyed upward at a high acceleration, on the basis of the rotating pick-up tools 14.

The pick-up rotor 12 is composed of multiple segments 22, which are connected to one another, at least in part, in an articulated manner, for adaptation to the ground 16. Individual segments 22 are shown as examples in FIGS. 1 and 5. The segments 22, which are connected to one another, at least in part, in an articulated manner, can be configured to have different widths or the same width.

According to the invention, in the present case—as can be seen well in FIG. 2—four guidance systems 24 are provided for a movable connection of the pick-up rotor 12, in particular a segment 22 of the pick-up rotor 12, to the machine frame 20 of the pick-up attachment 10. The position of the guidance system is made evident in FIGS. 2-5 by means of a border 24. Of course the border is not a component of the pick-up attachment 10.

Each guidance system 24 has a guide motion link 26 that is connected, in a locally fixed manner, to the machine frame 20, and a guide carriage 28 that is connected, in a locally fixed manner, to the pick-up rotor 12, in particular to a segment 22 of the pick-up rotor 12. The guide motion link 26 and the guide carriage 28 are connected and can be moved relative to one another, along two guide tracks or running tracks 38 that are parallel to and spaced apart from one another, in particular up and down, in other words away from the ground 16 and toward the ground 16.

The guide system 24 is a linear guide system.

Each guide system 24 is assigned to a guide element 18, namely a slide plate, in a centered manner.

The guidance system 24 provided here is configured as a roller guide, namely as a profile motion link guide or, in more concrete terms, as a track roller guide, in which track rollers 30 that are mounted on roller bearings roll on the aforementioned guide tracks or running tracks 38 of the guide motion link 26, as part of the guide carriage 28. For this purpose, precisely four track rollers 30a, 30b, 30c, 30d are arranged on the guide carriage 28, of which one upper and one lower track roller, in each instance, viewed in or counter to the direction of travel FR of the pick-up attachment 10, is supported in a left and in a right guide track or running track 38 of the guide motion link 26. This can be seen well in FIGS. 5 and 6.

The guidance system 24, in the present case the guide carriage 28, has stops 34, 36 for limiting the movement between the guide motion link 26 and the guide carriage 28, wherein preferably at least two upper stops 34 and one lower stop 36 limit the guide track or running track 38. The stop surfaces are situated on the machine frame 20 and on the guide motion link 26. It is advantageous if the stops 32, 34 are configured as stop buffers.

In the present case each linear guidance system 24 is set in such a manner, as can be seen well in FIG. 7, that its guide track or running track 38 are arranged perpendicular to the ground 16. Any directions that deviate from this or angles that deviate from this can be individually adjusted on each guidance system 24, depending on the desired effect.

### REFERENCE SYMBOL LIST

10 pick-up attachment
12 pick-up rotor
14 pick-up tool
16 ground
18 guide element
20 machine frame
22 segment
24 guidance system
26 guide motion link
28 guide carriage
30 track roller
30a track roller (bottom right)
30b track roller (top right)
30c track roller (bottom left)
30d track roller (top left)
32 contact point
34 stop (top)
36 stop (bottom)
38 guide/running track
40 transverse conveying screw
42 hold-down mechanism
FR direction of travel

1. A pick-up attachment (10) for a harvesting machine, preferably for a field chopper, particularly preferably for a self-propelled field chopper, comprising a pick-up rotor (12) having pick-up tools (14) for picking crop up from the ground (16), at least one guide element (18) that rests on the ground (16), which element takes on the guidance of the pick-up rotor (12) and guides it relative to the ground (16), and a machine frame (20) that is connected to the pick-up rotor (12), wherein the pick-up rotor (12) is composed of multiple segments (22) connected to one another at least partially in an articulated manner, for adaptation to the contours of the ground (16), and wherein at least one guidance system (24) is provided for a movable connection of the pick-up rotor (12), in particular of a segment (22) of the pick-up rotor (12), to the machine frame (20) of the pick-up attachment (10).

2. The pick-up attachment (10) according to claim 1, wherein the guidance system (24) has a first guide means, connected to the machine frame (20) in a locally fixed manner, preferably a guide motion link (26) or a guide rail, and a second guide means connected to the pick-up rotor (12), in particular to a segment (22) of the pick-up rotor (12), in a locally fixed manner, preferably a guide carriage (28), guide wagon or the like, wherein the first and the second guide means are connected to one another and can be moved relative to one another along a guide track or running track (38), in particular up and down, in other words away from the ground (16) and toward the ground (16).

3. The pick-up attachment (10) according to claim 1, wherein the guidance system (24) is a linear guidance system.

4. The pick-up attachment (10) according to claim 1, wherein multiple guidance systems (24) are provided, spaced apart from one another over the working width of the pick-up rotor (12).

5. The pick-up attachment (10) according to claim 1, wherein the number of guidance systems (24) corresponds to the number of guide elements (18) provided preferably within the working width of the pick-up rotor (12).

6. The pick-up attachment (10) according to claim 1, wherein each guidance system (24) is centrally assigned to a guide element (18), in particular to a slide plate.

7. The pick-up attachment (10) according to claim 1, wherein the guidance system (24) is configured as a slide guide having at least one slide bearing element or as a roller guide having at least one roller bearing element.

8. The pick-up attachment (10) according to claim 1, wherein the roller guide is a profile motion link guide or profile rail guide, in which rolling bodies, in particular balls or rollers, roll between the first guide means and the second guide means on a guide track or running track (38), or wherein the roller guide is a track roller guide in which track rollers mounted on rolling bodies roll between the first guide means and the second guide means on a guide track or running track (38).

9. The pick-up attachment (10) according to claim 1, wherein one or more track rollers (30), preferably four track rollers (30a, 30b, 30c, 30d) are arranged on the guide carriage (28), with an upper and a lower track roller, in each instance, seen in or counter to the direction of travel (FR) of the pick-up attachment (10), being supported in a left and a right guide track or running track (38) of the guide motion link (26).

10. The pick-up attachment (10) according claim 1, wherein the distance of the track rollers (30) from one another, in the vertical and/or the horizontal direction, in the guidance system (24), is selected to be as great as technically possible.

11. The pick-up attachment (10) according to claim 1, wherein the distance of the lower track rollers (30c, 30d) from the contact point (32) of the guide element (18), in particular of a slide plate, is selected to be as low as technically possible in the vertical direction.

12. The pick-up attachment (10) according to claim 1, wherein the guidance system (24), preferably the guide motion link (26) and/or the guide carriage (28), has one or more stops (34, 36) for limiting the movement between the guide means, wherein preferably at least one upper stop (34) and at least one lower (36) stop limit the guide track or running track (38).

13. The pick-up attachment (10) according to claim 1, wherein the stops (34, 36) are configured to be interchangeable, differently configured and/or differently adjustable, preferably attachable at different positions of the guidance system (24), in particular so as to be screwed on.

14. The pick-up attachment (10) according to claim 1, wherein the stops (34, 36) are structured as stop dampers or stop buffers and/or as fixed stops or as a combination of damping and fixed stops.

15. The pick-up attachment (10) according to claim 1, wherein the stops (34, 36) of the guidance systems (24) arranged closer to the center of the pick-up attachment (10) are selected and arranged in such a manner that the movement between the guide means is restricted more greatly than between the guide means of the guidance systems (24) arranged farther out.

16. The pick-up attachment (10) according to claim 1, wherein each linear guidance system (24) can be adjusted in such a manner that its guide track or running track (38) is arranged to be perpendicular to the ground (16) and/or in a direction that deviates from this or at an angle that deviates from this.

17. The pick-up attachment (10) according to claim 1, wherein a central guide motion link, in particular a continuous pressure plate or contact surface, is connected to or integrated into the machine frame (20), in a locally fixed manner and preferably in one piece.
